(19) United States
(12) Patent Application Publication
(10) Pub. No.: US 2025/0390925 A1
(43) Pub. Date: Dec. 25, 2025

(54) System and Method for Optimizing Cost-Effective Shopping

(71) Applicant: Russell Estey, Ball Ground, GA (US)

(72) Inventor: Russell Estey, Ball Ground, GA (US)

(21) Appl. No.: 19/229,304

(22) Filed: Jun. 5, 2025

Related U.S. Application Data
(60) Provisional application No. 63/663,709, filed on Jun. 25, 2024.

(51) Int. Cl. G06Q 30/0601; G06Q 30/0207

(52) U.S. Cl. CPC G06Q 30/0629; G06Q 30/0223; G06Q 30/0633; G06Q 30/0639

(57) ABSTRACT

The present invention is a price comparison and shopping system and associated method to optimize the shopping experience by enabling users to locate specials and discounts across multiple grocery and retail stores (i.e., stores). The system comprises a software application installed on a user device and a server system communicatively coupled via a network. The server includes a store data repository for storing prices and discounts, a coupon repository for active deals, and an optimization engine for determining cost-effective shopping strategies based on user inputs, preferences, and real-time data aggregated from multiple sources. The system provides recommendations for cost-effective stores and displays estimated savings to users, enabling informed decision-making. Additionally, the system facilitates online orders, pickups, deliveries, and in-person shopping by linking with store systems and providing navigation guides.

### CROSS-REFERENCE TO RELATED APPLICATION

The present application claims priority to, and the benefit of, U.S. Provisional Application No. 63/663,709 which was filed on Jun. 25, 2024, and is incorporated herein by reference in its entirety.

### FIELD OF THE INVENTION

The present invention generally relates to systems and methods for optimizing shopping experiences. More specifically, the invention relates to a price comparison and shopping optimization system designed to enable users to locate cost-effective grocery and retail stores (i.e., stores), streamline shopping processes, and maximize savings. The system includes a software application installed on user devices and a server system communicatively coupled via a network. The system receives a shopping list from a user and identifies grocery and retails stores and the corresponding estimated savings for each store. A user can select a store for completing the purchase through the application. Accordingly, this disclosure makes specific reference thereto the present invention. Nonetheless, it is to be appreciated that aspects of the present invention are also equally applicable to other like applications, devices, and methods of manufacture.

### BACKGROUND

By way of background, grocery shopping is generally performed on a daily, weekly or monthly basis, however, is often tedious and challenging task for many individuals and families. The process can be time-consuming, frustrating, and expensive. With the availability and access to multiple grocery and retail stores (i.e., stores), identifying the most cost-effective and efficient shopping option is challenging for individuals.

One of the primary difficulties lies in the inability to easily compare prices, sales, and discounts across different stores. The lack of visibility forces consumers to either spend excessive time manually searching through store advertisements, brochures, and online resources or risk overspending by shopping at a single store without considering alternatives. Additionally, not all grocery stores offer online ordering or shipping options, compelling customers to visit physical locations to retrieve their items. This limitation can be especially inconvenient for individuals with restricted mobility, busy schedules, or preferences for minimizing in-store interactions. Moreover, tracking and utilizing coupons or time-sensitive sales from multiple stores adds another layer of complexity. Managing such offers often becomes an overwhelming task, causing consumers to miss out on potential savings. The absence of an integrated solution to address these challenges underscores the need for a system that simplifies grocery shopping by optimizing cost savings and enhancing convenience.

Therefore, there exists a long-felt need in the art for a price comparison and shopping optimization system that effectively simplifies and enhances the grocery shopping experience for consumers. Specifically, there is a long-felt need for a solution that enables users to identify cost-effective grocery and retail stores (i.e., stores) without the time-consuming process of manually comparing prices and sales. Additionally, there is a need for a system that integrates multiple shopping methods, including in-person purchases, online orders, and delivery. Furthermore, there exists a long-felt need for a system that aggregates real-time pricing, discounts, and coupons across multiple stores. Moreover, there is a need for a solution that reduces overspending by providing personalized shopping strategies tailored to user preferences, dietary needs, and shopping habits. Finally, there is a need for a user-friendly platform that streamlines the entire shopping process, ensuring convenience, cost savings, and a seamless experience.

The subject matter disclosed and claimed herein, in one embodiment, comprises a price comparison and shopping optimization system. The system includes a software application installed on a user device, such as a smartphone or computer, and a server system communicatively coupled to the application via a communication network. The software application provides user interfaces that enable users to input shopping lists, set preferences, and choose between shopping modes, including in-person, pickup, or delivery. The server system features a store data repository that stores real-time pricing, sales, and discounts from various grocery and retail stores (i.e., stores), as well as a coupon repository for collecting and organizing available coupons. The system also includes an optimization engine that calculates personalized shopping strategies based on user inputs, preferences, and aggregated store data. Additionally, a fulfillment integration module facilitates order placement, pickup scheduling, and delivery by linking the system to third-party store systems.

In this manner, the price comparison and shopping optimization system of the present invention fulfills the aforementioned needs by providing a comprehensive and user-friendly solution for efficient and cost-effective grocery shopping. The system dynamically aggregates real-time data from multiple sources, enabling users to make informed decisions about where and how to shop. Furthermore, the system supports diverse shopping preferences, including in-person purchases and online orders, enhancing convenience and accessibility for a wide range of users. The system maximizes weekly or monthly savings on grocery bills, offering in person purchases, online orders, and shipping orders.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a price comparison and shopping system for enabling users to locate specials and discounts across multiple grocery and retail stores (i.e., stores). The system comprises a software application installed on a user device, a server system is communicatively coupled to the user device via a communication network, the server system comprises a store data repository configured to store weekly specials, regular prices, and discounts from various grocery and retail stores (i.e., stores), a coupon repository configured to collect and store available coupons and discounts associated with grocery and retail stores (i.e., stores), a user database configured to store user preferences, past shopping lists, and payment information, a data aggregator module configured to extract real-time information from third-party sources and update the store data repository and coupon repository, and an optimization engine configured to determine the most cost-effective shopping strategy for the shopping list of the user based on parameters including user preferences, price savings, convenience, and delivery time.

In another embodiment, a method for recommending cost-effective stores to a user is disclosed. The method includes receiving, by a software application installed on a user device, a shopping list input by the user, aggregating, by a data aggregator module, real-time pricing and discount information from multiple grocery and retail stores (i.e., stores), storing the aggregated information in a store data repository and coupon repository, determining, by an optimization engine, the most cost-effective combination of one or more stores for the shopping list based on parameters including price savings, user preferences, and delivery time, and enabling the user to select a store for completing the purchase through the application or redirecting the user to a third-party website for the selected store.

In another aspect, a system for optimizing shopping experiences is disclosed. The system includes a software application installed on a user device, configured to receive a shopping list and user preferences, display recommendations for cost-effective shopping strategies, a server system is communicatively coupled to the software application, the server system includes a store data repository for storing prices and discounts, a coupon repository for storing active deals and coupons, an optimization engine configured to calculate the most cost-effective shopping strategy based on user input, fulfillment integration module configured to communicate with grocery and retail store systems to facilitate order placement, pickups, and deliveries, and notify users of order status and delivery schedules.

In one embodiment, a method for facilitating in-person shopping for a user is disclosed. The method includes receiving a shopping list from the user via a software application installed on a user device, determining, by an optimization engine, at least one cost-effective retail or grocery store for the shopping list, displaying, on the user device, the identified store and the corresponding estimated savings, providing, via the software application, an organized shopping guide for efficient navigation within the store, and updating the system with purchase details upon completion of shopping by the user.

In another aspect, the application notifies users of inventory shortages or restocking predictions for desired items.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of price comparison system of the present invention in accordance with the disclosed architecture;

FIG. 2 illustrates a flow chart depicting a process of recommending cost-effective stores to a user by the system in accordance with one embodiment of the present invention;

FIG. 3 illustrates a flow chart depicting a process of providing in-person shopping process using the system of the present invention in accordance with the disclosed architecture;

FIG. 4 illustrates an exemplary home page displayed by the application and the website in accordance with one embodiment of the present invention;

FIG. 5 illustrates an exemplary user interface displayed by the application for showing different stores in accordance with one embodiment of the present invention;

FIG. 6 illustrates another user interface showing sales information on individual items in accordance with the disclosed architecture;

FIG. 7 illustrates a shopping list interface displayed in the application in accordance with one embodiment of the present invention;

FIG. 8 illustrates a user interface of the software application for suggesting an optimal store for shopping in accordance with one embodiment of the present invention; and

FIG. 9 illustrates a notification showing the saving for a user on shopping using the system of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a price comparison and shopping optimization system that effectively simplifies and enhances the grocery shopping experience for consumers. Specifically, there is a long-felt need for a solution that enables users to identify cost-effective grocery and retail stores (i.e., stores) without the time-consuming process of manually comparing prices and sales. Additionally, there is a need for a system that integrates multiple shopping methods, including in-person purchases, online orders, and delivery. Furthermore, there exists a long-felt need for a system that aggregates real-time pricing, discounts, and coupons across multiple stores. Moreover, there is a need for a solution that reduces overspending by providing personalized shopping strategies tailored to user preferences, dietary needs, and shopping habits. Finally, there is a need for a user-friendly platform that streamlines the entire shopping process, ensuring convenience, cost savings, and a seamless experience.

The present invention, in one exemplary embodiment, is a system for optimizing shopping experiences. The system includes a software application installed on a user device, configured to receive a shopping list and user preferences, display recommendations for cost-effective shopping strategies, a server system is communicatively coupled to the software application, the server system includes a store data repository for storing prices and discounts, a coupon repository for storing active deals and coupons, an optimization engine configured to calculate the most cost-effective shopping strategy based on user input, fulfillment integration module configured to communicate with grocery and retail store systems to facilitate order placement, pickups, and deliveries, and notify users of order status and delivery schedules.

Reference will now be made in detail to the present preferred embodiments of the invention, examples of which are illustrated in the accompanying drawings. Wherever possible, the same reference numerals are used in the drawings and the description to refer to the same or like parts.

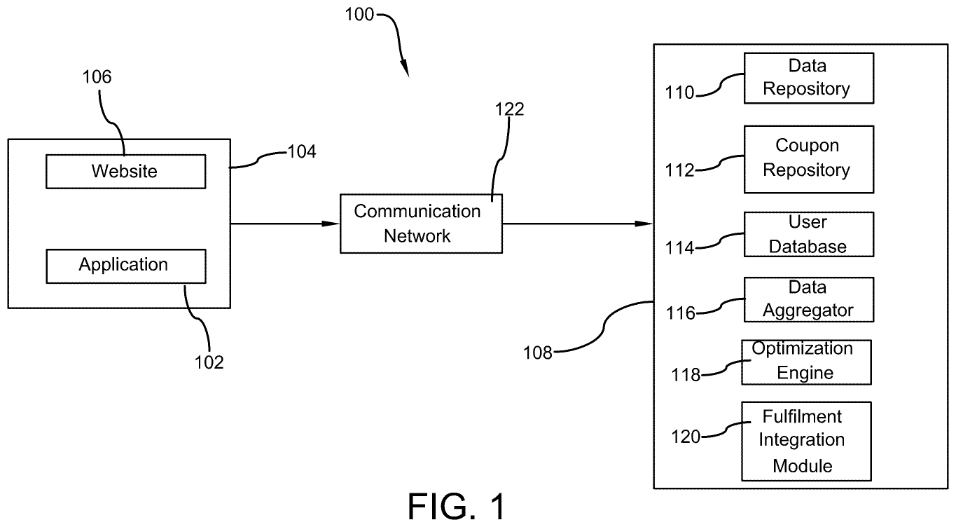

Referring initially to the drawings, FIG. 1 illustrates a schematic view of price comparison system of the present invention in accordance with the disclosed architecture. The price comparison system 100 of the present invention is designed to streamline and enhance the shopping experience by enabling users to locate specials and discounts across multiple grocery and retail stores (i.e., stores). The price comparison and shopping system 100 includes a software application 102 installed in a user device 104 such as a smartphone. A website 106 accessible via a browser can also provide the same functionality and offerings of the application 102 to users. Examples of the user device 104 may include, but are not limited to, a desktop, a notebook, a laptop, a handheld computer, a touch sensitive device, a computing device, a smartphone, and/or a smart watch. It will be apparent to a person of ordinary skill in the art that the user device 102 may include any device/apparatus that is capable of manipulation by the user. The software application 102 is configured to provide a plurality of user interfaces for enabling users to input their shopping list, set preferences, and choose between shopping modes (in-person, pickup, delivery).

A server system 108 is included in the system 100 for providing advanced functionalities for enabling users to access the system 100. The server system 108 includes a store data repository 110 which can be in the form of a relational, object storage, block storage, file storage, or any other non-relational database. The store data repository 110 is configured to store weekly specials, regular prices, and discounts from various grocery and retail stores (i.e., stores). A coupon repository 112 is configured to collect and store available coupons and discounts of a plurality of grocery and retail stores (i.e., stores). The coupons and discounts are autonomously made available to users when shopping with the corresponding (i.e., geographically proximal) grocery and retail stores (i.e., stores). A user database 114 stores user information including but not limited to user preferences (such as vegan, vegetarian, non-vegetarian), past shopping lists for recommending stores for future shopping, payment information, and more.

A data aggregator module 116 is designed to aggregate data stored in the repositories 110, 112 from a plurality of grocery and retail stores (i.e., stores). It should be noted that in some embodiments, grocery and retail stores (i.e., stores) register in the cost-effective shopping system 100 or in some embodiments, the aggregator module 116 fetches or extracts (i.e., ‘mines’) information from websites, applications, brochures, and more of grocery and retail stores (i.e., stores). The data aggregator module 116 is adapted to extract real-time information from the third-party sources and the information is updated continuously in the repositories 110, 112.

An optimization engine 118 is configured to perform price calculations based on shopping lists or shopping items of user and provides a customized and personalized shopping strategy for each user of the price comparison and shopping system 100. The optimization engine 118 is coupled to all the databases of the system 100 and determines the best purchasing strategy for the user's shopping list. The optimization engine 118 can include different parameters including but not limited to user preferences, price savings, convenience, and delivery time for providing a shopping strategy to the users.

A fulfilment integration module 120 links the system 100 to different retail and grocery store systems for online orders, pickups, and deliveries. The fulfilment integration module 120 facilitates communication between the system 100 and 3^{rd} parties for providing notifications to users about online and offline delivery of the purchased items.

Preferably, the system 100 has a client-server architecture wherein a user accesses the system 100 and its offerings through the application 102 or the website 106 installed in the user device 104. The server system 108 and the user device 104 are communicatively coupled to each other via a communication network 122 such as Internet. The communication network 122 may be associated with an application layer for implementation of communication protocols based on one or more communication requests from the user device 104 and the server system 108. The communication data may be transmitted or received, via the communication protocols. Examples of the communication protocols may include, but are not limited to, Hypertext Transfer Protocol (HTTP), File Transfer Protocol (FTP), Simple Mail Transfer Protocol (SMTP), Domain Network System (DNS) protocol, Common Management Interface Protocol (CMIP), Transmission Control Protocol and Internet Protocol (TCP/IP), User Datagram Protocol (UDP), Long Term Evolution (LTE) communication protocols, or any combination thereof.

The server system 108 is a network of computers, a software framework, or a combination thereof, that may provide a generalized approach to create the server implementation. The server system 108 may be maintained by a storage facility management authority or a third-party entity that facilitates service enablement and resource allocation operations of the system 100.

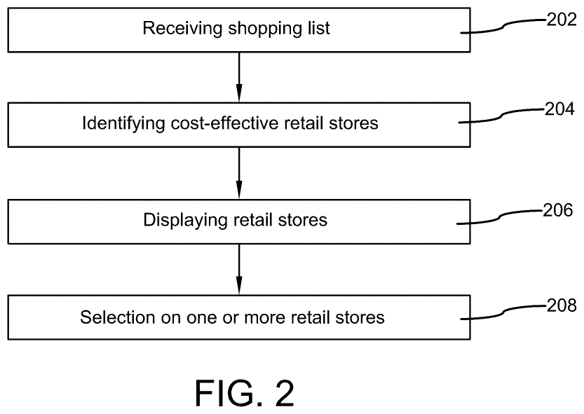

FIG. 2 illustrates a flow chart depicting a process of recommending cost-effective stores to a user by the system in accordance with one embodiment of the present invention. The price comparison and fulfillment system 100 using the application 102 and website 106 maximizes cost savings for users by recommending cost-effective retail and grocery stores while minimizing the time and effort typically spent on comparing prices, searching for sales, and managing purchases. Initially, a user inputs their shopping list in the application 102 using input device of the user device 104 (Step 202). Then, the optimization module 118 using the input from aggregator module 116 and databases, identifies the most cost-effective one or more retail stores (Step 204). The application 102 may display a combination of retail stores based on cost-effective combination of shopping list items (Step 206). The user can receive estimated savings for each store for enabling the user to make an informed decision. Finally, based on preferences of the user, one or more stores are selected by the user to order items through the application 102 (Step 208). In some embodiments, the application 102 may redirect the user to the third-party website of the selected store for making an order of the shopping list items.

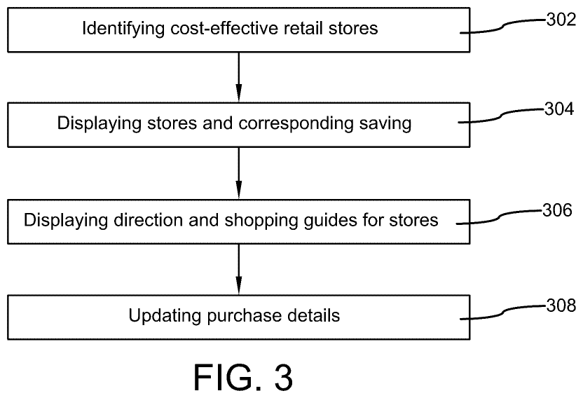

FIG. 3 illustrates a flow chart depicting a process of providing in-person shopping process using the system of the present invention in accordance with the disclosed architecture. In the present embodiment, upon receiving shopping list of a user, the price comparison and fulfillment system 100 identifies at least one cost-effective retail and grocery store (Step 302). The identified stores and corresponding saving on each store are displayed by the application 102 (Step 304). Thereafter, upon receiving selection of a store from the displayed stores, the application 102 displays directions and an organized shopping guide to the selected store for efficient in-store navigation (Step 306). Finally, the user completes shopping in-store and the purchase details are updated in the system (Step 308).

In some embodiments, the users may receive detailed instructions such as Items A, B, and C are cheapest at store 1 at 50% discount and items D, E, and F are cheapest at store 2 at 30% discount. Recommendations may include pickup, delivery, or a combination.

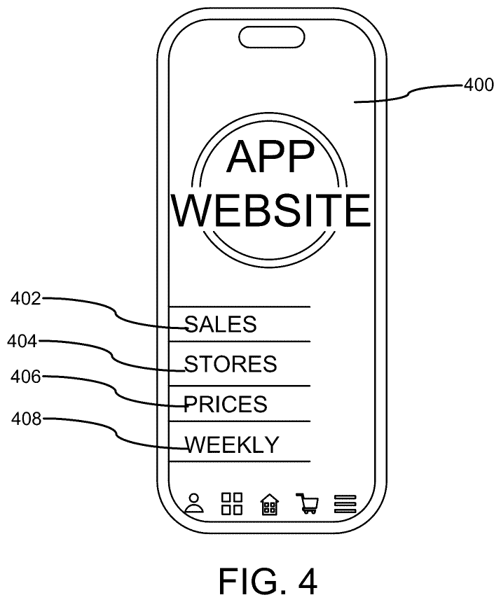

FIG. 4 illustrates an exemplary home page displayed by the application 102 and the website 106 in accordance with one embodiment of the present invention. As illustrated, the home A “Sales” option 402 when selected or clicked, provides active sales running on different stores. The sales are updated in real-time and helps users to make a quick and informed selection of individual items for shopping. A “Stores” option 404 enables users to browse different stores available on the application 102 for selecting shopping items. The stores displayed to the user may be filtered based on past purchases of the user, location of the user, and many other criteria.

A “Prices” option 406 upon selection provides prices of individual items. The prices option 406 may also display prices of items marked as favorite by users. For an individual item, prices may be sorted based on prices for a quick selection and decision by users. A “Weekly” option 408 provides special weekly sales, weekly discount coupons, loyalty points, and more to users.

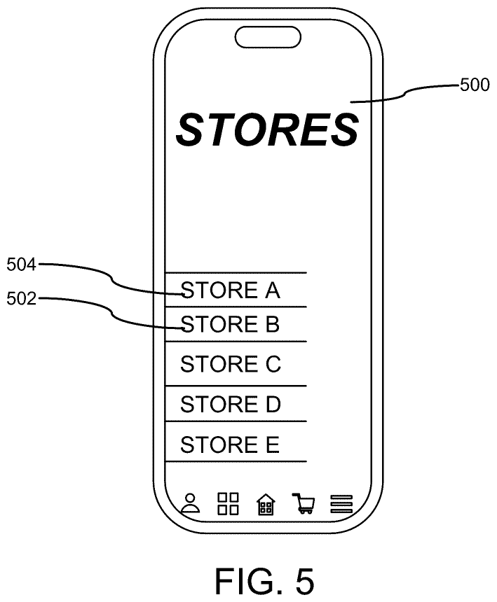

FIG. 5 illustrates an exemplary user interface displayed by the application for showing different stores in accordance with one embodiment of the present invention. Upon selection of the “Stores” option 404, the application 102 provides the interface 500 which displays a list 502 of available grocery and retail stores (i.e., stores) in the system 100. Based on preferences of a user, some of the stores may not be displayed to the user and any store 504 from the list 502 can be selected by the user for selection of items.

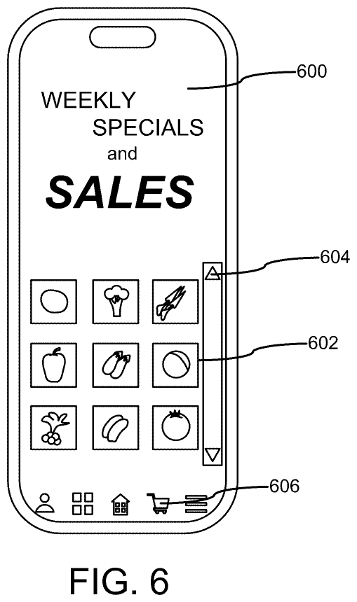

FIG. 6 illustrates another user interface showing sales information on individual items in accordance with the disclosed architecture. As illustrated, the Sales interface 600 displays a list 602 of items which are on sale in different stores. The list 602 can be scrolled using a scroll bar 604 and a user can select one or more items from the list to add to the cart 606 for shopping. In some embodiments, upon selection of an item, different stores offering the selected item at a discount may be displayed for enabling the user to select the most cost-effective store. Items which are a part of the weekly sales may be highlighted in a specific color or can be filtered by users.

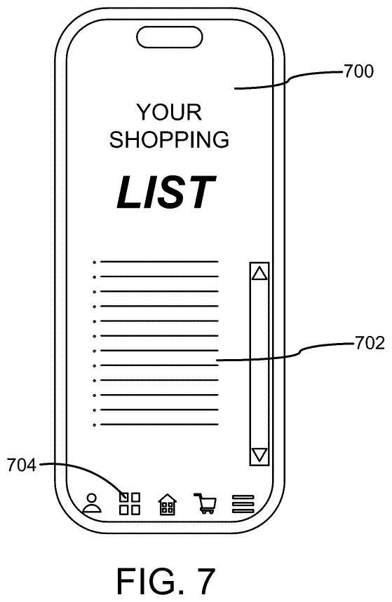

FIG. 7 illustrates a shopping list interface displayed in the application in accordance with one embodiment of the present invention. A user can input his shopping list in the application 102 by selecting items, inputting names of items, or uploading list of items. In some embodiments, the application 102 may enable scanning of items to add the items to the shopping list. A shopping list 702 of the user is displayed in the interface 700 and can be reviewed by the user before making an order. It should be noted that shopping can be done from a single store or more than one store as per preferences of the user. Further, the list 702 can be displayed in a grid form using the grid button 704.

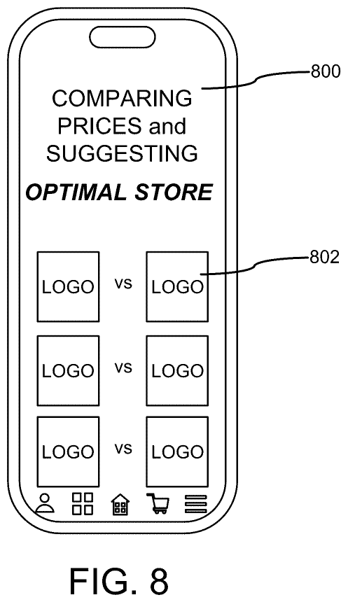

FIG. 8 illustrates a user interface of the software application for suggesting an optimal store for shopping in accordance with one embodiment of the present invention. As illustrated, the interface 800 displays comparison between a plurality of stores for a shopping list of a user. The comparison includes logos or indicia 802 of individual companies and the user can select a comparison to compare the discounts and savings on shopping from the compared stores. The application 102 can also suggest stores based on the past selections by users and based on their shopping habits.

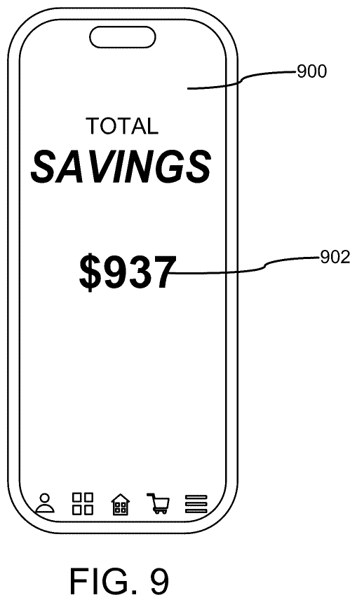

FIG. 9 illustrates a notification showing the saving for a user on shopping using the system of the present invention in accordance with the disclosed structure. The application 102 is configured to display the total savings on shopping for individual shopping lists, weekly shopping, and monthly shopping. As illustrated, the interface 900 displays the total savings 902 for a user on the shopping list and can be configured on weekly or monthly basis as per preferences of the users.

The application 102 can also notify users if a desired item is running low at a particular store and predict when out-of-stock items will be available based on past inventory trends. Further, in cases where an item is not available at a store, the application 102 can suggest substitutes or alternative stores. In some embodiments, a user can bid for bulk purchases or exclusive deals with participating retailers and enable users to lock in prices for items before visiting the store or placing an order.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “price comparison and fulfillment system”, “cost-effective shopping system”, “price comparison and shopping system”, and “system” are interchangeable and refer to the system and method for optimizing cost-effective shopping 100 of the present invention.

Notwithstanding the forgoing, the system and method for optimizing cost-effective shopping 100 of the present invention can be of any suitable configuration as is known in the art without affecting the overall concept of the invention, provided that it accomplishes the above stated objectives. One of ordinary skill in the art will appreciate that the system and method for optimizing cost-effective shopping 100 as shown in the FIGS. are for illustrative purposes only, and that many other configurations of the system and method for optimizing cost-effective shopping 100 are well within the scope of the present disclosure. Although the dimensions of the system and method for optimizing cost-effective shopping 100 are important design parameters for user convenience, the system and method for optimizing cost-effective shopping 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A price comparison system for streamlining shopping comprising:
a user device;
a software application;
a server system;
a store data repository;
a coupon repository;
a data aggregator module; and
a user database;
wherein said software application providing a plurality of user interfaces for enabling users to input their shopping list, set preferences, and choose a shopping mode;
wherein said shopping mode is selected from the group consisting of in-person shopping, pickup, online ordering, and delivery;
wherein said server system having said store data repository including a non-relational database;
wherein said store data repository is selected from the group consisting of a relational database, object storage, block storage, and file storage;
wherein said store data repository stores weekly specials, regular prices, and discounts from a plurality of stores;
wherein said coupon repository collects and stores coupons from said plurality of stores; and
further wherein said user database stores user information based upon preferences of the user.

2. The price comparison system for streamlining shopping of claim 1, wherein said coupons are autonomously made available to the user based on a geographically proximal store to the user from said plurality of stores.

3. The price comparison system for streamlining shopping of claim 2, wherein said user database stores user information and payment information based upon past shopping lists for selected stores of said plurality of stores.

4. The price comparison system for streamlining shopping of claim 3, wherein said data aggregator module aggregates data stored in said store data repository and said coupon repository from said plurality of stores.

5. The price comparison system for streamlining shopping of claim 4, wherein said user device selected from the group consisting of a smartphone, a desktop, a notebook, a laptop, a handheld computer, a touch sensitive device, a computing device, and a smart watch.

6. The price comparison system for streamlining shopping of claim 5, wherein said data aggregator module extracts information from a plurality of sources, and further wherein said plurality of sources is selected from the group consisting of a website, an application, and a brochure of said plurality of stores.

7. The price comparison system for streamlining shopping of claim 6, wherein said extracting information is real-time information.

8. The price comparison system for streamlining shopping of claim 7 further comprising an optimization engine for performing price calculations based upon said preferences of the user and said extracting information.

9. The price comparison system for streamlining shopping of claim 8 further comprising a fulfilment integration module linking said in-person shopping, said pickup, said online ordering, and said delivery with said plurality of stores.

10. A method of maximizing cost savings by comparison shopping, the method comprising the steps of:
providing a user device, a software application, a server system, a store data repository, a coupon repository, a data aggregator module, a user database, an optimization module, and a fulfilment integration module, wherein said software application providing a plurality of user interfaces for enabling a user to input a shopping list, set preferences, and choose a shopping mode;
inputting the user said shopping list in said software application using said user device;
selecting said shopping mode from the group consisting of in-person shopping, pickup, online ordering, and delivery;
selecting said store data repository from the group consisting of a relational database, object storage, block storage, and file storage, wherein said store data repository stores weekly specials, regular prices, and discounts from a plurality of stores;
collecting and storing coupons in said coupon repository from said plurality of stores;
storing user information in said user database based upon preferences of the user;
autonomously providing said coupons to the user based on a geographically proximal store to the user from said plurality of stores;
aggregating data with said data aggregator module using data stored in said store data repository and said coupon repository from said plurality of stores;
performing price calculations with said optimization engine based upon said preferences of the user and said extracting information;
linking said in-person shopping, said pickup, said online ordering, and said delivery with said plurality of stores using said fulfilment integration module; and
identifying a cost effect of one or more of said shopping mode from said shopping list.

11. The method of maximizing cost savings by comparison shopping of claim 10, wherein said user database stores user information and payment information based upon past shopping lists for selected stores of said plurality of stores.

12. The method of maximizing cost savings by comparison shopping of claim 11, wherein said user device selected from the group consisting of a smartphone, a desktop, a notebook, a laptop, a handheld computer, a touch sensitive device, a computing device, and a smart watch.

13. The method of maximizing cost savings by comparison shopping of claim 12, wherein said data aggregator module extracts information from a plurality of sources, and further wherein said plurality of sources is selected from the group consisting of a website, an application, and a brochure of said plurality of stores.

14. The method of maximizing cost savings by comparison shopping of claim 13, wherein said extracting information is real-time information.

15. A method of maximizing cost savings by comparison shopping, the method comprising the steps of:
providing a user device, a software application, a server system, a store data repository, a coupon repository, a data aggregator module, a user database, an optimization module, and a fulfilment integration module, wherein said software application providing a plurality of user interfaces for enabling a user to input a shopping list, set preferences, and choose a shopping mode;
inputting the user said shopping list in said software application using said user device;
selecting said shopping mode from the group consisting of in-person shopping, pickup, online ordering, and delivery;
selecting said store data repository from the group consisting of a relational database, object storage, block storage, and file storage, wherein said store data repository stores weekly specials, regular prices, and discounts from a plurality of stores;
collecting and storing coupons in said coupon repository from said plurality of stores;
storing user information in said user database based upon preferences of the user;
autonomously providing said coupons to the user based on a geographically proximal store to the user from said plurality of stores;
aggregating data with said data aggregator module using data stored in said store data repository and said coupon repository from said plurality of stores;
performing price calculations with said optimization engine based upon said preferences of the user and said extracting information;
linking said in-person shopping, said pickup, said online ordering, and said delivery with said plurality of stores using said fulfilment integration module;
identifying a cost effect of one or more of said shopping mode from said shopping list; and
displaying directions and a shopping guide to at least one of said plurality of stores for said in-person shopping.

16. The method of maximizing cost savings by comparison shopping of claim 15, wherein said user database stores user information and payment information based upon past shopping lists for selected stores of said plurality of stores.

17. The method of maximizing cost savings by comparison shopping of claim 15, wherein said user device selected from the group consisting of a smartphone, a desktop, a notebook, a laptop, a handheld computer, a touch sensitive device, a computing device, and a smart watch.

18. The method of maximizing cost savings by comparison shopping of claim 15, wherein said data aggregator module extracts information from a plurality of sources, and further wherein said plurality of sources is selected from the group consisting of a website, an application, and a brochure of said plurality of stores.

19. The method of maximizing cost savings by comparison shopping of claim 18, wherein said extracting information is real-time information.

20. The method of maximizing cost savings by comparison shopping of claim 15 further comprising the step of displaying on said software application a corresponding saving of said at least one of said plurality of stores for said in-person shopping.
